(19) United States
(12) Patent Application Publication
(10) Pub. No.: US 2025/0377604 A1
(43) Pub. Date: Dec. 11, 2025

(54) IMAGE FORMING APPARATUS

(71) Applicant: CANON KABUSHIKI KAISHA, Tokyo (JP)

(72) Inventor: RYOICHI KAWASUMI, Ibaraki (JP)

(21) Appl. No.: 19/228,911

(22) Filed: Jun. 5, 2025

(30) Foreign Application Priority Data
Jun. 10, 2024 (JP) 2024-093666

(51) Int. Cl. G03G 15/01; B41J 2/447; B41J 2/47; B41J 29/377; B41J 29/393; G03G 15/00; G03G 15/04; G03G 15/041; G03G 21/20

(52) U.S. Cl. CPC G03G 15/011; B41J 2/447; B41J 2/47; B41J 29/377; B41J 29/393; G03G 15/0189; G03G 15/04036; G03G 15/0415; G03G 15/80; G03G 21/206

(57) ABSTRACT

An image forming apparatus includes a main body having a first surface and a second surface, a first photosensitive member which is arranged inside of the main body, and is configured to bear a first toner image, a first exposure portion which is arranged inside of the main body, and is configured to expose the first photosensitive member with light, a second photosensitive member which is arranged inside of the main body, and is configured to bear a second toner image, a second exposure portion which is arranged inside of the main body, and is configured to expose the second photosensitive member with light, a controller which is arranged on the first surface of the main body, and is configured to transmit a first control signal for controlling the first exposure portion and a second control signal for controlling the second exposure portion.

### BACKGROUND

### Field of the Technology

The present disclosure relates to an image forming apparatus including an exposure device.

### Description of the Related Art

An image forming apparatus employing an electrophotographic system forms an image by exposing a photosensitive drum with light. The image forming apparatus thus includes an exposure device. In the exposure device disclosed in Japanese Patent Application Laid-open No. 2023-025381, a plurality of light emitting elements such as light emitting diodes (LEDs) and organic electro-luminescence (EL) elements are arrayed in a line.

In the exposure device described in Japanese Patent Application Laid-open No. 2023-025381, an exposure unit (exposure device) is provided for each of a plurality of photosensitive drums. That is, the exposure device disclosed in Japanese Patent Application Laid-open No. 2023-025381 includes a plurality of exposure units. Since signal lines are wired to transmit control signals to each of the plurality of exposure units, the number of signal lines increases.

An image forming unit including the photosensitive drum is structurally arranged inside a main body of the image forming apparatus. The exposure device is also arranged in the vicinity of the photosensitive drum. On the other hand, the electrical component unit including a control unit to control operations of the image forming unit and the exposure device is provided in a group on a rear side of the main body of the image forming apparatus. Thus, the wiring of signal lines for transmitting control signals to the exposure unit tends to become complicated.

### SUMMARY

An image forming apparatus according to an aspect of the present disclosure includes a main body having a first surface and a second surface, a first photosensitive member which is arranged inside of the main body, and is configured to bear a first toner image, a first exposure portion which is arranged inside of the main body, and is configured to expose the first photosensitive member with light, a second photosensitive member which is arranged inside of the main body, and is configured to bear a second toner image, a second exposure portion which is arranged inside of the main body, and is configured to expose the second photosensitive member with light, a controller which is arranged on the first surface of the main body, and is configured to transmit a first control signal for controlling the first exposure portion and a second control signal for controlling the second exposure portion, and a relay unit which is arranged on the second surface of the main body, and is configured to relay the first control signal and the second control signal which are transmitted from the controller, wherein the relay unit includes a reception connector configured to receive the first control signal and the second control signal, a first connector configured to transmit the first control signal received by the reception connector to the first exposure portion and a second connector configured to transmit the second control signal received by the reception connector to the second exposure portion.

Features of the present disclosure will become apparent from the following description of embodiments with reference to the attached drawings. The following description of embodiments are described by way of example.

### BRIEF DESCRIPTION OF THE DRAWINGS

FIG. 1 is a configuration view for illustrating an image forming apparatus.

FIG. 2 is a perspective view for illustrating an exposure unit as viewed from above.

FIG. 3 is a perspective view for illustrating the exposure unit as viewed from below.

FIG. 4 is a perspective view for illustrating the exposure unit mounted on a cartridge tray.

FIG. 5 is a sectional view taken along the line B-B of FIG. 4.

FIG. 6 is a perspective view for illustrating a cooling unit.

FIG. 7 is a sectional view taken along the line A-A of FIG. 1.

FIG. 8 is a sectional view taken along the line C-C of FIG. 7.

FIG. 9 is an explanatory view for illustrating an electric component portion of the image forming apparatus.

FIG. 10 is a perspective view for illustrating an image forming apparatus.

FIG. 11 is a configuration view for illustrating a left side surface of the image forming apparatus.

### DESCRIPTION OF THE EMBODIMENTS

Now, referring to the accompanying drawings, description is given of at least one embodiment of the present disclosure. Some embodiments of the present disclosure are directed to provide an image forming apparatus in which the wiring for the control signal is simplified.

FIG. 1 is a configuration view for illustrating an image forming apparatus of at least one embodiment. An image forming apparatus 100 of at least one embodiment is a four-full-color printer employing a tandem-intermediate transfer system using an electrophotographic process. The image forming apparatus 100 forms an image on a sheet S based on a signal input to a controller (not shown) from an external device (not shown) such as a personal computer. FIG. 1 shows an internal configuration of the image forming apparatus 100 as viewed from the front side.

The image forming apparatus 100 includes an image forming portion 1, as an image forming unit, arranged substantially at a middle in a main body 100A. The image forming portion 1 is used to form toner images of four colors of yellow (Y), magenta (M), cyan (C), and black (K). The image forming portion 1 includes four image forming units U corresponding to the respective colors. The four image forming units U have a substantially common configuration. Description is given here of a configuration of an image forming unit U forming a cyan toner image, and description of configurations of image forming units U forming toner images of the other colors is omitted.

The image forming unit U includes a drum unit and a developing unit. The drum unit includes a rotary drum-type electrophotographic photosensitive member (hereinafter referred to as “photosensitive drum”) 2 serving as an image bearing member. The developing unit includes a developing sleeve 5 for developing an electrostatic latent image formed on the photosensitive drum 2 to generate a toner image. The drum unit and the developing unit can be replaced or mounted to and removed from the image forming apparatus 100.

The drum unit includes, in addition to the photosensitive drum 2, a charging roller 3 for charging the surface of the photosensitive drum 2, and a drum cleaner portion (not shown). The developing unit includes, in addition to the developing sleeve 5, a screw 7 for stirring toner and supplying the stirred toner to the developing sleeve 5. An exposure unit 4 is arranged between the drum unit and the developing unit as an exposure device. The exposure unit 4 includes a plurality of light emitting elements such as LED elements or organic EL elements.

A cartridge tray 30 is arranged below the image forming unit U. The cartridge tray 30 guides insertion of the drum unit and the developing unit into the image forming apparatus 100. A cooling unit 60 is arranged below the cartridge tray 30. The cooling unit 60 includes a fan 62 for cooling the exposure unit 4.

An intermediate transfer belt unit 8 is provided above the image forming portion 1, and a sheet cassette 12 is provided below the image forming portion 1. The intermediate transfer belt unit 8 includes: four primary transfer rollers 6 arranged so as to be opposed to the photosensitive drums 2 for the respective colors; a belt drive roller 10; and a belt 9. The sheet cassette 12 includes two cassettes, specifically, a cassette 12A arranged in an upper stage and a cassette 12B arranged in a lower stage.

Toner bottles 22Y, 22M, 22C, and 22K corresponding to the respective colors are arranged on the upper side of the intermediate transfer belt unit 8. The toner bottles 22Y, 22M, 22C, and 22K store replenishing toners for the respective developing units of the four image forming units U. The toner bottles 22Y, 22M, 22C, and 22K can be mounted and removed for replacement. An appropriate amount of toner is supplied at an appropriate timing by a toner supplying mechanism (not shown) from each of the toner bottles 22Y, 22M, 22C, and 22K corresponding to the respective developing units of the four image forming units U.

In the image forming process, electrostatic latent images are formed on the respective photosensitive drums 2 of the four image forming units U. As a preparation operation therefor, a high voltage is applied to the charging roller 3 under a state in which the charging roller 3 is brought into pressure contact with the photosensitive drum 2 so that the surface of the rotating photosensitive drum 2 is uniformly charged. The light emitting elements of the exposure unit 4 irradiate the uniformly charged surface of the photosensitive drum 2 with light. The exposure unit 4 is an exposure portion for controlling light emission of each light emitting element based on a control signal which indicates an image and is transmitted from a controller (not shown). The potential of the surface of the photosensitive drum 2 is a value that varies between a position irradiated with light and a position not irradiated with light. This difference allows an electrostatic latent image corresponding to the control signal to be formed on the surface of the photosensitive drum 2.

The developing sleeve 5 includes a built-in magnet, and the surface of the developing sleeve 5 is uniformly coated with charged toner inside of the developing unit. Inside of the developing unit, the screw 7 circulates and conveys the toner at high speed. The rotation speed of the screw 7 is extremely higher than the rotation speed of the developing sleeve 5 or the photosensitive drum 2. Accordingly, the developing sleeve 5 is uniformly coated with toner without unevenness. A high voltage is applied to the developing sleeve 5 in a path different from the path of applying a high voltage to the charging roller 3, to thus cause the toner to adhere to the electrostatic latent image to develop the toner. In this manner, the toner image is formed on the photosensitive drum 2.

The toner images of the respective colors formed on the respective photosensitive drums 2 are primarily transferred in a sequential manner onto the surface of the belt 9 rotated in the counterclockwise direction of FIG. 1 by the belt drive roller 10. In at least one embodiment, toner images are transferred in the order of yellow, magenta, cyan, and black. In this manner, the toner images of the respective colors are formed in a superimposed manner on the belt 9.

The image forming apparatus has, on the right side of the image forming portion as viewed from the front side, a sheet conveyance path provided for conveying the sheet S from the lower side to the upper side. On the sheet conveyance path, in the order from the lower side toward the upper side, a sheet feeding roller pair 13, a registration roller pair 15, a secondary transfer roller 16, a fixing device 19, and a discharge roller pair 20 are provided. The secondary transfer roller 16 is brought into abutment against the belt drive roller 10 of the intermediate transfer belt unit 8 across the belt 9 at a predetermined pressing force, and forms a secondary transfer nip portion 17 between the secondary transfer roller 16 and the belt 9.

The sheet feeding roller pair 13 is driven at a predetermined control timing according to the image forming process so that the sheets S are separated and fed one by one from any one of the sheet cassette 12A and the sheet cassette 12B. The fed sheet S is conveyed to the registration roller pair 15 through the sheet conveyance path. The registration roller pair 15 corrects the skew feeding of the sheet S, and conveys the sheet S to the secondary transfer nip portion 17 in synchronization with the timing at which the toner images transferred onto the belt 9 are conveyed to the secondary transfer nip portion 17.

The secondary transfer nip portion 17 nips and conveys the belt 9 and the sheet S. The secondary transfer nip portion 17 secondarily transfers the toner images of the four colors formed on the belt 9 onto the sheet S in a collective manner. In this manner, unfixed toner images are formed on the sheet S. The sheet S is conveyed from the secondary transfer nip portion 17 to the fixing device 19. The fixing device 19 applies heat and pressure to the sheet S having the toner images formed thereon, to fix the toner images to the sheet S. The sheet S having the toner images fixed thereon by the fixing device 19 is discharged, as a product of image formation, by the discharge roller pair 20 to a discharge tray 21 provided above the toner bottles 22Y, 22M, 22C, and 22K.

### <Exposure Unit>

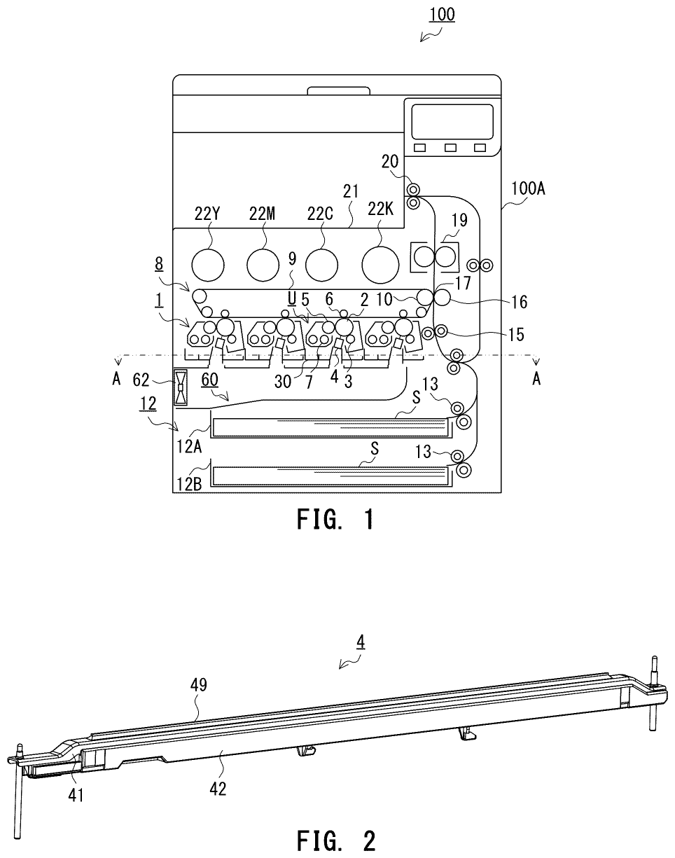

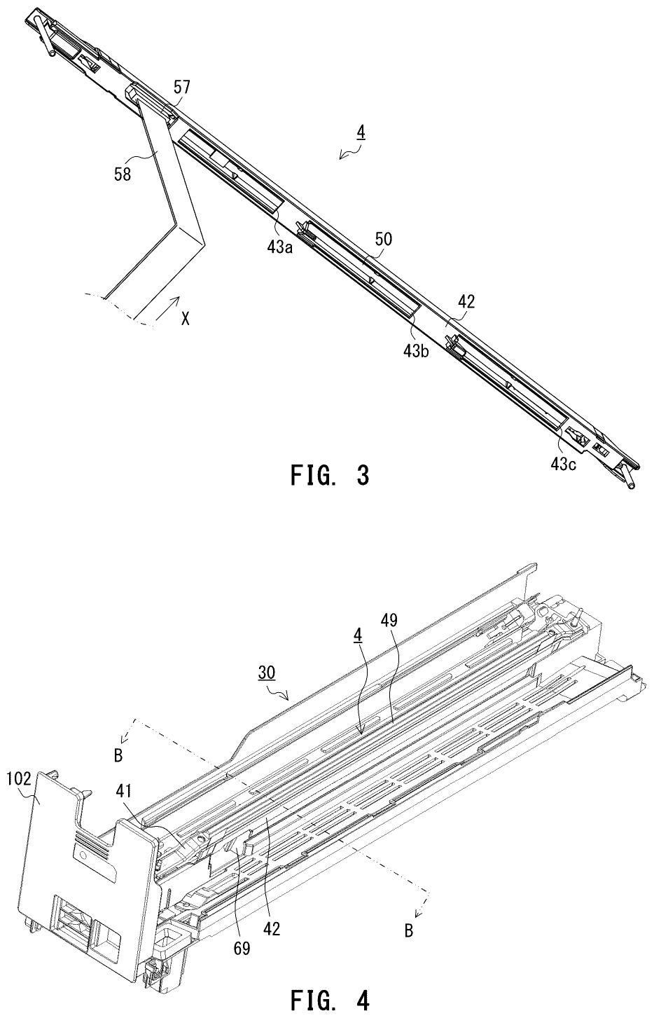

FIG. 2 is a perspective view for illustrating the exposure unit 4 as viewed from above. FIG. 3 is a perspective view for illustrating the exposure unit 4 as viewed from below. Under a state in which the exposure unit 4 is mounted to the image forming apparatus 100 as illustrated in FIG. 1, a direction in which the photosensitive drum 2 is positioned as viewed from the exposure unit 4 is an upper side of the exposure unit 4. Further, in FIG. 1, a direction in which the cooling unit 60 is positioned as viewed from the exposure unit 4 is a lower side of the exposure unit 4.

As illustrated in FIG. 2, the exposure unit 4 has a shape of being extended in a drum shaft direction of the photosensitive drum 2 when being mounted to the image forming apparatus 100. That is, the longitudinal direction of the exposure unit 4 is substantially parallel to the drum shaft direction of the photosensitive drum 2. The exposure unit 4 includes a lens assembly 49 in its upper portion. The lens assembly 49 is fixed to a holder 41 with an adhesive or the like. A slit is formed in a surface of the holder 41 opposed to the photosensitive drum 2. The lens assembly 49 is inserted in the slit. Light output from each of the light emitting elements of the exposure unit 4 is imaged on the surface of the photosensitive drum 2 by the lens assembly 49. The holder 41 is supported by a support member 42.

As illustrated in FIG. 3, the exposure unit 4 includes a mounting board 50. On a first surface of the mounting board 50 opposed to the lens assembly 49, a plurality of light emitting elements are arrayed in the longitudinal direction. In more detail, the mounting board 50 includes a printed board having wiring and the like formed thereon. The mounting board 50 further includes a plurality of chips mounted on a first surface of the printed board. In addition, a plurality of light emitting elements are respectively formed in the plurality of chips. As described above, LED elements, organic EL elements, and the like are used as the plurality of light emitting elements. The mounting board 50 is fixed to the holder 41 with an adhesive or the like. The light emitting elements are provided on the first surface of the mounting board 50, and hence the first surface of the mounting board 50 is a light emitting surface.

As illustrated in FIG. 3, a connector 57 is mounted on a second surface of the mounting board 50 opposite to the first surface. The connector 57 is connected to a flexible flat cable (hereinafter referred to as “FFC”) 58 serving as a signal line to which a control signal for controlling the drive of the light emitting elements is to be transmitted. The connector 57 is provided in the vicinity of one end portion of the exposure unit 4 in the longitudinal direction of the exposure unit 4. In at least one embodiment, under a state in which the exposure unit 4 is mounted to the image forming apparatus 100, the connector 57 is arranged on the front side of FIG. 1. Further, as illustrated in FIG. 3, the second surface of the mounting board 50 is exposed to a space surrounded by the holder 41 and the support member 42. As is understood from FIG. 3, an opening for allowing the space and the outside of the exposure unit 4 to be in communication with each other is formed in a bottom surface of the support member 42. In at least one embodiment, three openings 43a to 43c are formed.

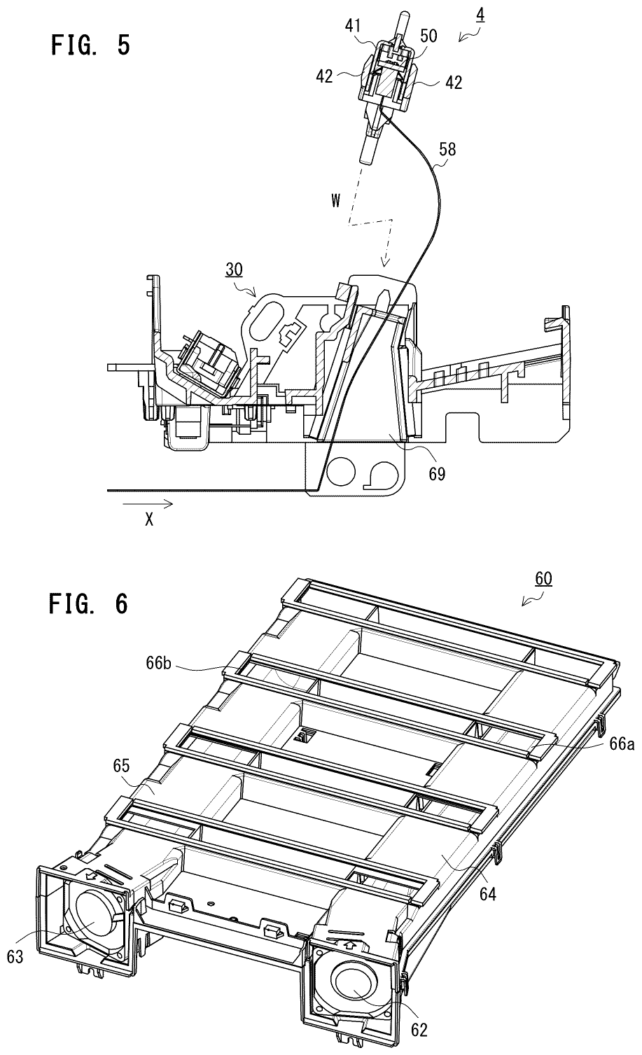

Next, description is given of a state in which the exposure unit 4 is mounted to the image forming apparatus 100. The exposure unit 4 in at least one embodiment is provided integrally with the cartridge tray 30 in a case where the exposure unit 4 is mounted to the image forming apparatus 100. FIG. 4 is a perspective view for illustrating the exposure unit 4 mounted on the cartridge tray 30 as viewed from above. FIG. 5 is a sectional view taken along the line B-B of FIG. 4.

The cartridge tray 30 is a tray for mounting the drum unit and the developing unit to guide insertion into the main body 100A of the image forming apparatus 100. The exposure unit 4 is arranged in a space defined between the drum unit and the developing unit substantially at the middle of the cartridge tray 30. An inner door 102 is provided so as to be turnable at a front end of the cartridge tray 30. The front end of the cartridge tray 30 is a part positioned on the front side of FIG. 1 in a case where the cartridge tray 30 is mounted to the image forming apparatus 100. The inner door 102 is provided so as to be turnable in order to close an opening for mounting the image forming unit U after the image forming unit U is mounted to the image forming apparatus 100.

The cartridge tray 30 includes, substantially at the middle, an elevating duct 69 that can be raised and lowered in the vertical direction of FIG. 5. The exposure unit 4 is mounted to the elevating duct 69 in a W direction so as to be provided integrally with the cartridge tray 30. The elevating duct 69 has a tubular shape having openings at an upper end and a lower end. The elevating duct 69 is configured to be, in a case where the exposure unit 4 is mounted thereon, in communication with the back surface (second surface) of the mounting board 50 of the exposure unit 4. That is, the space to which the second surface of the mounting board 50 is exposed as described above and the space surrounded by the elevating duct 69 are in communication with each other via the opening at the bottom surface of the support member 42 and the opening at the upper end of the elevating duct 69.

The FFC 58 is arranged so as to overlap the elevating duct 69 in order to prevent interfering with the insertion of the drum unit and the developing unit into the image forming apparatus 100. That is, as viewed from the front side of the apparatus, the FFC 58 is positioned on the front side of the elevating duct 69. The FFC 58 transmits a signal in a direction indicated by the arrow X of FIG. 5.

### <Cooling Unit>

The exposure unit 4 dissipates heat at the time of drive of the light emitting elements. In particular, in a case where the image forming process is repeated at high frequency (the productivity is high), or in a case where an image having a high image density is successively output, the light emission time period of the light emitting elements becomes long, and further the light emitting amount of the light emitting elements becomes large. Accordingly, the heat generation amount of the exposure unit 4 is increased. Further, the exposure unit 4 is arranged in the vicinity of the developing unit using toner. The toner is easily changed in quality due to the heat. In view of the above, the image forming apparatus 100 of at least one embodiment includes a cooling unit 60 for cooling the exposure unit 4.

FIG. 6 is a perspective view for illustrating the cooling unit 60 for cooling the exposure unit 4. The cooling unit 60 includes, at an end portion thereof, two fans 62 and 63. One of the two fans 62 and 63 functions as an intake fan for taking in fresh air (air outside of the image forming apparatus 100), and another one thereof functions as an exhaust fan for exhausting air. The fans 62 and 63 are provided in any surface of the main body 100A of the image forming apparatus 100. In at least one embodiment, the fans 62 and 63 are provided in a left side surface of the main body 100A. The fan 62 arranged closer to the front surface of the image forming apparatus 100 functions as the intake fan, and the fan 63 arranged closer to the back surface thereof functions as the exhaust fan.

In a case where a wide space is present in front of the fan, the intake/exhaust volume of the fan can be increased. Accordingly, it has been considered in the related art that it is preferred not to arrange a blocking object around the image forming apparatus 100. In contrast, in at least one embodiment, the fans 62 and 63 are arranged in one surface. Accordingly, even when a blocking object is arranged in the vicinity of some of the surfaces of the image forming apparatus 100, the intake/exhaust volumes of the fans 62 and 63, and in turn, the cooling performance of the cooling unit 60 can be maintained. Further, in a case where the intake fan and the exhaust fan are arranged with a distance as in at least one embodiment, the cooling performance of the cooling unit 60 can be improved. The reason therefor is because, even when high-temperature air is released from the exhaust fan, the temperature of air taken in by the intake fan is less liable to be increased.

The cooling unit 60 is arranged directly below the cartridge tray 30 as illustrated in FIG. 1. The cooling unit 60 is configured to be in communication with the mounting board 50 inside of the exposure unit 4 through the elevating duct 69. The cooling unit 60 includes an intake duct 64 for sending the fresh air supplied by the fan 62 to the elevating duct 69, and an exhaust duct 65 for sending the air supplied after cooling the exposure unit 4 to the fan 63. Four openings 66a are formed in an upper surface of the intake duct 64. Four openings 66b are formed in an upper surface of the exhaust duct 65. In FIG. 6, reference symbols are provided to the opening 66a and the opening 66b corresponding to the cyan image forming unit U. The opening 66a of the intake duct 64 is in communication with the opening 43a (FIG. 3) of the support member 42 of the exposure unit 4 via the elevating duct 69. The opening 66b of the exhaust duct 65 is in communication with the opening 43c (FIG. 3) of the support member 42 of the exposure unit 4 via the elevating duct 69. As described above, the cooling unit 60 is arranged by utilizing the space directly below the image forming portion 1, and hence the exposure unit 4 can be efficiently cooled with the shortest airflow path (see FIG. 1).

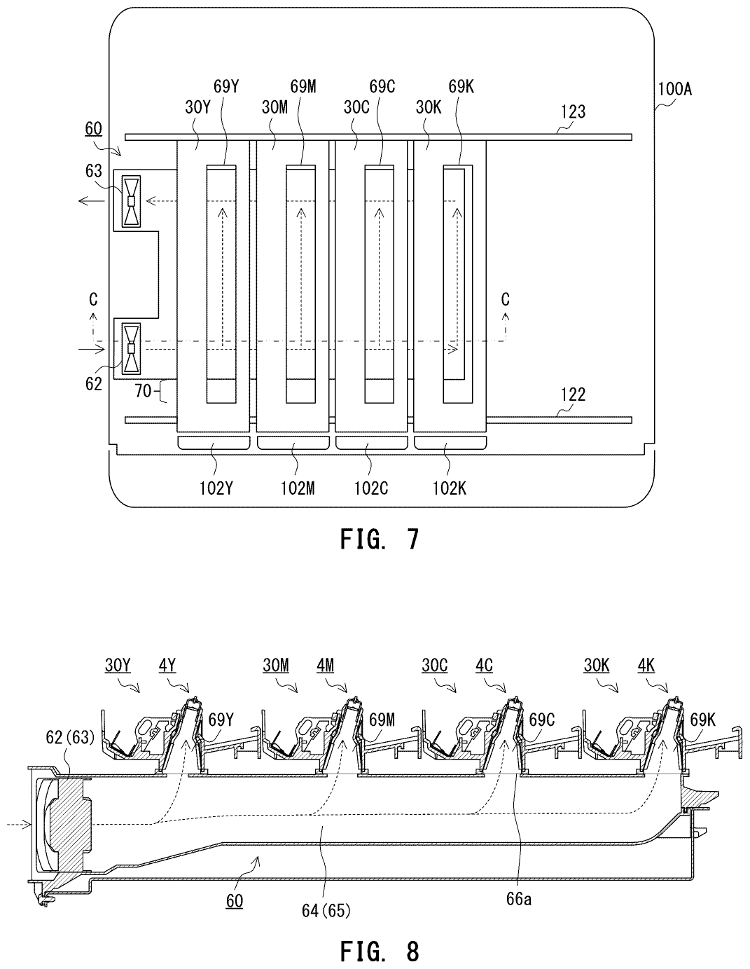

With reference to FIG. 7 and FIG. 8, description is given of an airflow path for cooling the exposure unit 4 by the cooling unit 60. FIG. 7 is a sectional view taken along the line A-A of FIG. 1. The upper side of FIG. 7 corresponds to the back surface side of the main body 100A of the image forming apparatus 100. FIG. 7 shows the elevating duct 69 in a transparent state so that the positional relationship between the cooling unit 60 and the cartridge tray 30 is clearly represented. In the following description, Y, M, C, and K at the ends of the reference symbols indicate the corresponding colors (yellow, magenta, cyan, and black).

In FIG. 7 and FIG. 8, the airflow path of the cooling unit 60 is indicated by the broken lines. The fan 62 takes in the fresh air outside of the image forming apparatus 100 into the image forming apparatus 100. The air taken into the image forming apparatus 100 passes through the inside of the elevating ducts 69 (69Y, 69M, 69C, and 69K) from the lower side of the cartridge trays 30 (30Y, 30M, 30C, and 30K) corresponding to the respective colors. The air passes through the elevating duct 69 to be sent to a space surrounded by the holder 41 and the support member 42. The second surface of the mounting board 50 is exposed to the space. Thus, the mounting board 50 is cooled by the sent air. After that, the air passes through the elevating duct 69 and the exhaust duct 65 to be exhausted to the outside of the image forming apparatus 100 via the fan 63. As described above, the cooling unit 60 cools the exposure unit 4.

The cooling unit 60 is arranged in a space between a front side plate 122 and a rear side plate 123. The front side plate 122 is a side plate to be arranged on the front surface side of the image forming apparatus 100 with respect to the cooling unit 60, and the rear side plate 123 is a side plate to be arranged on the back surface side of the image forming apparatus 100 with respect to the cooling unit 60. The image forming units U are provided between the front side plate 122 and the rear side plate 123. The cooling unit 60 is arranged between the front side plate 122 and the rear side plate 123, and hence the exposure unit 4 is efficiently cooled with the shortest airflow path.

Description is given of the arrangement of the FFCs 58 in FIG. 7. The FFCs 58 are provided from the left side surface of the image forming apparatus 100 to pass through a range 70 of FIG. 7 and then be connected to the exposure units 4 of the respective colors. The range 70 is a space between the front side plate 122 and the cooling unit 60. With the FFCs 58 being wired in such a path, the FFCs 58 are prevented from interfering with the airflow path of the cooling unit 60. Accordingly, the cooling efficiency is not reduced by the FFCs 58.

FIG. 8 is a sectional view taken along the line C-C of FIG. 7. In order to avoid complexity of the drawings, the reference symbols of the respective portions of the exposure units 4 illustrated in FIG. 5 are omitted. In order from the lower side of the image forming apparatus 100, the cooling unit 60, the elevating ducts 69 (69Y, 69M, 69C, and 69K), and the exposure units 4 (4Y, 4M, 4C, and 4K) are arranged to be vertically stacked. The fresh air taken in by the fan 62 passes through the intake duct 64 of the cooling unit 60 to be blown to the exposure units 4 (4Y, 4M, 4C, and 4K). The air that has entered the inside of the exposure unit 4 advances to the back surface side of the main body 100A, and passes through the elevating duct 69 to enter the exhaust duct 65 of the cooling unit 60. Then, the air inside of the exhaust duct 65 is exhausted by the fan 63 to the left side surface of the image forming apparatus 100. The cross-sectional configuration of the exhaust duct 65 is substantially the same as that of the intake duct 64.

### <Signal Transmission Path to Exposure Unit>

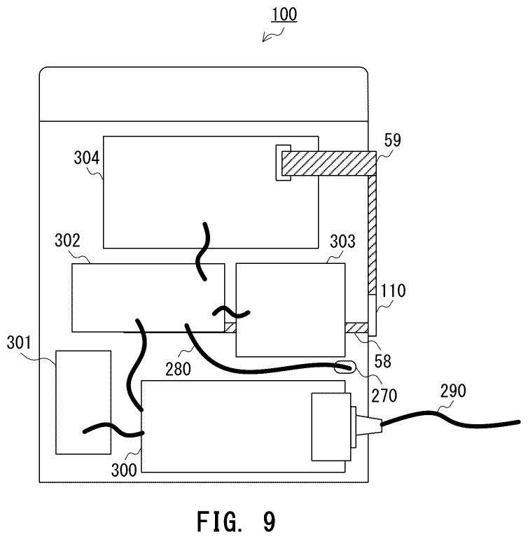

FIG. 9 is an explanatory view for illustrating an electric component portion of the image forming apparatus 100. FIG. 9 shows an arrangement of a plurality of electric component portions such as controllers and connection between the electric component portions in a case where the image forming apparatus 100 is viewed from the back surface side.

The electric component portions in at least one embodiment includes a power supply portion 300 to which a power supply cable 290 is to be connected, and controllers 301, 302, 303, and 304 for controlling the units inside of the image forming apparatus 100. The power supply portion 300 is supplied with electric power from a commercial power supply via the power supply cable 290. The power supply portion 300 supplies electric power to each of the controllers 301, 302, 303, and 304 based on the electric power supplied from the commercial power supply. In at least one embodiment, the controller 304 controls the exposure units 4. The controller 304 is, for example, a controller for controlling the entire image forming apparatus 100. The power supply portion 300 and the controllers 301 to 304 are provided on the back surface side of the main body 100A of the image forming apparatus 100. The controller 304 is arranged at the uppermost portion among the power supply portion 300 and the controllers 301 to 304. The power supply portion 300 and the controllers 301 to 304 are each formed of, for example, an electrical board having electrical components mounted thereon. The relay unit 110 is provided in the left side surface of the main body 100A of the image forming apparatus 100 (right side in FIG. 9).

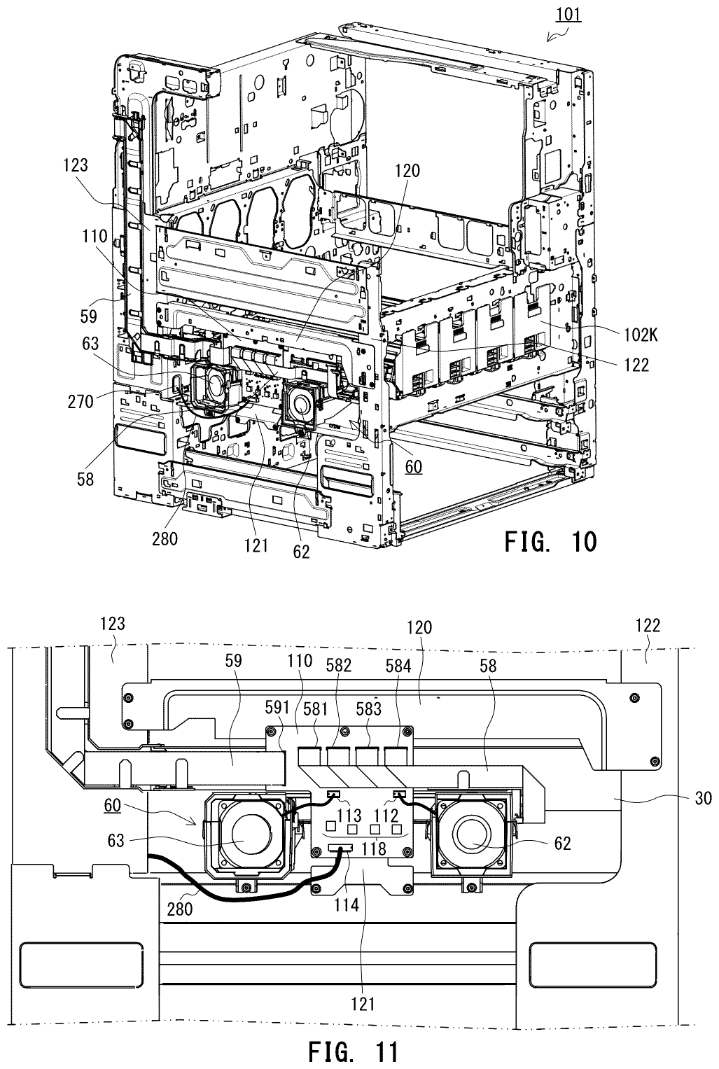

An FFC 59 connects the controller 304 and the relay unit 110 to each other. The FFC 59 is one cable encompassing all signal lines for transmitting control signals for the exposure units 4 of the respective colors of yellow, magenta, cyan, and black. The control signals for the exposure units 4 are generated based on image data. With the exposure units 4 being controlled by the control signals, the electrostatic latent images are formed on the corresponding photosensitive drums 2, and the toner images are formed. Connectors are provided at both ends of the FFC 59. One connector of the FFC 59 is connected to the controller 304, and another connector thereof is connected to the relay unit 110. As illustrated in FIG. 9, the FFC 59 is arranged from the connector of the controller 304 toward the left side surface of the main body 100A of the image forming apparatus 100. The FFC 59 that has reached the left side surface of the main body 100A is routed in the left side surface of the main body 100A to be connected to the relay unit 110 (FIG. 10).

The relay unit 110 transmits the control signals for the exposure units 4 of the respective colors of yellow, magenta, cyan, and black, which have been transmitted by the FFC 59, to the corresponding exposure units 4 with the control signals being separated by colors. Accordingly, four FFCs 58 corresponding to the exposure units 4 of the four colors are connected to the relay unit 110. The four FFCs 58 are connected to the corresponding exposure units 4, respectively. With such a configuration, the FFC 59 and the FFCs 58 are used to transmit the control signals of the respective colors from the controller 304 to the exposure units 4 via the relay unit 110.

Further, bundled wires 280 connect the controller 302 and the relay unit 110 to each other. The bundled wires 280 include a plurality of wires that are bundled. The bundled wires 280 are a power line for supplying, from the controller 302, electric power to a semiconductor device mounted on the relay unit 110. Examples of the semiconductor device mounted on the relay unit 110 include an application specific integrated circuit (ASIC). An opening 270 is formed in the back surface of the image forming apparatus 100. One connector of the bundled wires 280 is connected to the controller 302, and another connector thereof is routed from the back surface to the left side surface of the main body 100A of the image forming apparatus 100 via the opening 270, to be connected to the relay unit 110. The controller 302 in at least one embodiment outputs a control signal for controlling the operations of the fans 62 and 63.

Description is given of the arrangement of the FFCs 58 and 59 in the left side surface of the main body 100A. FIG. 10 is a perspective view as viewed from the front left side of the image forming apparatus 100. FIG. 10 shows the image forming apparatus 100 under a state in which an exterior cover is removed. For the sake of easy understanding of the transmission paths of the signals to the exposure units 4, FIG. 10 shows only a frame body 101 of the image forming apparatus 100 and surrounding components around the signal transmission paths.

As described with reference to FIG. 9, the FFC 59 is routed from the back surface side to the left side surface of the image forming apparatus 100 (frame body 101). As illustrated in FIG. 10, the FFC 59 is arranged from the upper side toward the lower side on the rear side of the left side surface of the image forming apparatus 100. Next, the FFC 59 is bent so as to change the direction to the front side, and the FFC 59 is connected to the relay unit 110. The relay unit 110 is an electrical board for dividing the control signals of the respective colors, which have been transmitted by the FFC 59, by colors, and transmitting the control signals to the exposure units 4 of the corresponding colors via the FFCs 58. The plurality of FFCs 58 connected to the relay unit 110 are arranged to be stacked. The plurality of FFCs 58 are arranged from the back surface side toward the front surface side in the left side surface of the image forming apparatus 100 (frame body 101). Next, the FFCs 58 are bent toward the right side. Then, the plurality of FFCs 58 each pass through the lower side of the cartridge tray 30 (range 70 of FIG. 7) to be connected to the corresponding exposure unit 4. FIG. 10 shows the inner door 102 (102K) for putting in and out the cartridge tray 30, which is arranged on the front surface side of the image forming apparatus 100. The cartridge tray 30 is arranged on the rear side of the corresponding inner door 102.

As described above, the bundled wires 280 routed from the back surface of the main body 100A via the opening 270 are connected to the relay unit 110. The bundled wires 280 that have passed through the opening 270 are routed below the fan 63 to be connected to the relay unit 110. The bundled wires 280 are connected to the relay unit 110 in an arrangement and a path that are different from those of the FFC 59.

FIG. 11 is a configuration view for illustrating the left side surface of the frame body 101 of the image forming apparatus 100. The front side plate 122 and the rear side plate 123 are coupled to each other by a stay 120. The relay unit 110 is fixed to the stay 120 and a stay 121 which is a frame body component, at a plurality of points by screws. In this manner, the relay unit 110 is firmly fixed to the frame body 101, and, at the same time, the ground potential is stabilized by the fixing points.

The FFC 59 wired from the upper side on the rear side of the left side surface of the image forming apparatus 100 is branched into the plurality of FFCs 58 corresponding to the respective colors by the relay unit 110. Accordingly, the relay unit 110 includes a reception connector 591 to which the FFC 59 is to be connected, and connectors 581 to 584 to which the plurality of FFCs 58 are to be connected. The control signals output from the controller 304 are transmitted to the relay unit 110 by the FFC 59, and are separated by colors by the relay unit 110 to be transmitted by the FFCs 58 to the respective exposure units 4. The plurality of FFCs 58 corresponding to the respective colors are arranged to be stacked. Each of the FFCs 58 pass above the fan 62 to be bent in a direction toward the inside of the image forming apparatus 100. Then, each of the FFCs 58 is wired to the lower side of the cartridge tray 30. The exposure units 4 are arranged side by side in a direction substantially perpendicular to the left side surface of the image forming apparatus 100, and hence the FFCs 58 are wired so as to be bent substantially perpendicular.

The relay unit 110 is arranged between the fan 62 and the fan 63. In at least one embodiment, in the front-rear direction of the image forming apparatus 100 (right-left direction of FIG. 11), from the front side, the fan 62, the relay unit 110, and the fan 63 are arranged in the stated order. The cooling unit 60 is arranged so as to cool the exposure units 4 in a compact and efficient manner. As described above, the fan 62 and the fan 63 are arranged with a distance, and thus the cooling performance of the cooling unit 60 is improved. In view of the above, when the relay unit 110 is arranged between the fan 62 and the fan 63, the image forming apparatus 100 can be downsized. Further, in order to arrange the relay unit 110 close to the exposure units 4 without inhibiting the airflow path obtained by the cooling unit 60, it is appropriate to arrange the relay unit 110 in the space between the fan 62 and the fan 63.

The relay unit 110 includes an ASIC 118 and a power line connector 114. The bundled wires 280 which have been provided from the controller 302 to pass through the opening 270 and have been routed to the left side surface of the main body 100A are routed below the fan 63 to be connected to the power line connector 114. The ASIC 118 is responsible for at least part of processing of the control signals to be transmitted to the exposure units 4.

With the ASIC 118 being mounted to the relay unit 110 instead of being mounted to the controller 304, the control signals for the exposure units 4 are processed in the vicinity of the exposure units 4. Accordingly, a path for inputting the processed control signal to the exposure unit 4 can be shortened. Further, the processing for controlling the exposure units 4 is collectively performed in the relay unit 110, and hence it is possible to easily adapt to the change of the exposure unit 4. Thus, the expandability is increased.

The relay unit 110 includes fan connectors 112 and 113. Signal lines (bundled wires) for transmitting drive signals for controlling the drive of the fans 62 and 63 are respectively connected to the fan connectors 112 and 113. This configuration means that the control signals are transmitted to the fans 62 and 63 via the relay unit 110. The relay unit 110 is arranged between the fan 62 and the fan 63, and hence the transmission paths of the control signals to the fans 62 and 63 can be collected to the relay unit 110. In this manner, the number of signal lines or the like for transmitting the control signals to the fans 62 and 63 can be reduced, and thus the cost can be reduced.

The bundled wires 280 also have a function of supplying electric power to the fans 62 and 63 in addition to the function of transmitting the control signals to the fans 62 and 63. The relay unit 110 generates drive signals for the fans 62 and 63 based on the control signals for the fans 62 and 63 acquired from the controller 302 by the bundled wires 280. As described above, the FFC 59 for transmitting the control signals for the respective exposure units 4 and the bundled wires 280 for transmitting other signals and electric power are clearly divided and connected to the relay unit 110 in two systems. This configuration means that the signals are input to the relay unit 110 with the signals being divided to the FFC 59 to be used for high-speed control signal transmission that has a large influence of noise, and the bundled wires 280 to be used for electric power transmission that has a small influence of noise. In this manner, the possibility of mixture of noise due to mutual interference is reduced.

The connectors of the fans 62 and 63 and the relay unit 110 are all collected to the left side surface of the image forming apparatus 100. Accordingly, the fans 62 and 63 and the FFCs 58 and 59 can be easily replaced by removing the left cover of the image forming apparatus 100. As described above, collecting those members in one surface of the image forming apparatus 100 is advantageous also from the viewpoint of service exchangeability. In at least one embodiment, the members are collected in the left side surface, but the members may be collected in other surfaces.

A shielded FFC covered with a shield that is effective in noise suppression is used as the FFC 59 to be used for transmission of the control signals of the respective colors from the controller 304 to the relay unit 110. A non-shielded FFC that is at least partially free of being covered with the shield that is effective in noise suppression is used as the FFCs 58 to be used for transmission of the control signals from the relay unit 110 to the exposure units 4 corresponding to the respective colors. The shielded FFC is more expensive than the non-shielded FFC, and is harder and bulkier. Accordingly, the shielded FFC is more disadvantageous in wire routing than the non-shielded FFC.

From the controller 304 to the relay unit 110, a path is long and has a small number of bent parts, and hence it is appropriate to use a shielded FFC that is effective in noise suppression, as the FFC 59. It is appropriate to use non-shielded FFCs that are effective in routing, as the FFCs 58 in which four FFCs are arranged so as to be stacked and which are wired at positions having a large number of bent parts. The FFC 58 has a short path, and hence the possibility that the noise affects the signal is low even when the non-shielded FFC is used. With the types of the FFCs being separately used depending on the wiring positions as described above, the influence of noise to the signal can be kept to the minimum while the cost increase is suppressed. Further, the wiring for the control signal transmitted to the exposure unit can be simplified.

The image forming apparatus 100 of at least one embodiment includes the relay unit 110. Thus, transmission of the control signal from the control unit 304 to the exposure unit 4 is realizable by wiring of a simple signal wire. In at least one embodiment, description has been given of the case in which the exposure unit 4 is an exposure unit in which a plurality of light emitting elements are arrayed in one direction, but the configuration of the exposure device is not limited thereto. As long as a configuration in which the exposure device is provided for each color so as to correspond to the photosensitive drum 2 of each color is employed, the configuration of the image forming apparatus 100 described above is enabled. Accordingly, the exposure device may adopt, for example, a laser scanning system in which the photosensitive drum 2 is scanned by rotation of a rotary polygon mirror.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-093666, filed Jun. 10, 2024, which is hereby incorporated by reference herein in its entirety.

What is claimed is:

1. An image forming apparatus, comprising:
a main body having a first surface and a second surface;
a first photosensitive member which is arranged inside of the main body, and is configured to bear a first toner image;
a first exposure portion which is arranged inside of the main body, and is configured to expose the first photosensitive member with light;
a second photosensitive member which is arranged inside of the main body, and is configured to bear a second toner image;
a second exposure portion which is arranged inside of the main body, and is configured to expose the second photosensitive member with light;
a controller which is arranged on the first surface of the main body, and is configured to transmit a first control signal for controlling the first exposure portion and a second control signal for controlling the second exposure portion; and
a relay unit which is arranged on the second surface of the main body, and is configured to relay the first control signal and the second control signal which are transmitted from the controller,
wherein the relay unit includes:
a reception connector configured to receive the first control signal and the second control signal;
a first connector configured to transmit the first control signal received by the reception connector to the first exposure portion; and
a second connector configured to transmit the second control signal received by the reception connector to the second exposure portion.

2. The image forming apparatus according to claim 1, further comprising:
a first flexible flat cable which connects the controller and the reception connector of the relay unit to each other, and is configured to transmit the first control signal and the second control signal;
a second flexible flat cable which connects the first connector of the relay unit and the first exposure portion to each other, and is configured to transmit the first control signal; and
a third flexible flat cable which connects the second connector of the relay unit and the second exposure portion to each other, and is configured to transmit the second control signal.

3. The image forming apparatus according to claim 2,
wherein the first flexible flat cable is covered with a shield, and
wherein the second flexible flat cable and the third flexible flat cable are each at least partially free of being covered with a shield.

4. The image forming apparatus according to claim 2, wherein the first flexible flat cable is a signal line that is more effective in noise suppression than the second flexible flat cable, and is a signal line that is more effective in noise suppression than the third flexible flat cable.

5. The image forming apparatus according to claim 1, further comprising:
an intake fan configured to take in air for cooling the first exposure portion and the second exposure portion; and
an exhaust fan configured to exhaust the air.

6. The image forming apparatus according to claim 5, wherein the intake fan and the exhaust fan are arranged on the second surface of the main body.

7. The image forming apparatus according to claim 6, wherein the relay unit is provided between the intake fan and the exhaust fan.

8. The image forming apparatus according to claim 5,
wherein each of the first exposure portion and the second exposure portion includes:
a board having a light emitting surface on which a plurality of light emitting elements are arranged; and
a lens arranged so as to be opposed to the light emitting surface, and
wherein the air is blown to a surface of the board opposite to the light emitting surface to cool the board.

9. The image forming apparatus according to claim 5, wherein the relay unit is configured to transmit a drive signal for controlling drive of the intake fan and the exhaust fan.

10. The image forming apparatus according to claim 9, wherein the relay unit includes:
a first fan connector to which a signal line for transmitting the drive signal to the intake fan is to be connected; and
a second fan connector to which a signal line for transmitting the drive signal to the exhaust fan is to be connected.

11. The image forming apparatus according to claim 10,
wherein the intake fan and the exhaust fan are arranged on the second surface of the main body, and
wherein the relay unit is provided between the first fan and the second fan.
